(19) United States
(12) Patent Application Publication
(10) Pub. No.: US 2025/0381582 A1
(43) Pub. Date: Dec. 18, 2025

(54) DISPENSER FOR DISPENSING MATERIALS STORED INSIDE A CARTRIDGE

(71) Applicant: medmix Switzerland AG, Haag (EP)

(72) Inventors: Marc TINKER, Newbury (GB); Alex BALL, Marlborough (GB); Matt LYNDON, Eastleigh (GB)

(21) Appl. No.: 18/875,909

(22) PCT Filed: Jun. 19, 2023
(86) PCT No.: PCT/EP2023/066460

§ 371 Date: Dec. 17, 2024

(30) Foreign Application Priority Data
Jun. 21, 2022 (EP) 22180198.8

(51) Int. Cl. B05C 17/01; B05C 17/005

(52) U.S. Cl. CPC B05C 17/0116; B05C 17/00596

(57) ABSTRACT

A dispenser for dispensing materials stored inside a cartridge includes a support sleeve, a receiving space to receive a cartridge in the support sleeve, a piston connected to a piston driving mechanism moveable through the receiving space to urge a material stored in the cartridge along a dispensing axis towards an outlet of the cartridge to dispense the material, a handle including a trigger to activate movement of the piston driving mechanism along the dispensing axis, the receiving space being formed by a frame, with the frame being configured to hold the support sleeve during dispensing, and the receiving space including a pivot mechanism to act between the frame and the support sleeve such that the support sleeve is capable of pivoting about a pivot axis aligned perpendicularly to the dispensing axis from a first position to a second position, and vice versa.

### CROSS-REFERENCE TO RELATED APPLICATIONS

This application is a U.S. National Stage Application of International Application No. PCT/EP2023/066460, filed on Jun. 19, 2023, which claims priority to European Patent Application No. 22180198.8, which was filed on Jun. 21, 2022, the contents of each of which are hereby incorporated by reference.

### BACKGROUND

### Technical Field

The present disclosure relates to a dispenser for dispensing materials stored inside a cartridge, for example a 1K- or a 2K-cartridge.

### Background Information

Dispensers for dispensing materials at an application site are commonly known in the state of the art. Such dispensers are usually configured to dispense materials stored inside cartridges, for example so called 1K- or 2K-cartridges. For this reason known dispensers are configured to repeatedly receive the cartridges and to urge the materials from the cartridges towards a dispensing outlet, for example by a piston and corresponding piston rod.

Once the cartridge is emptied, they are usually disconnected from the dispenser and replaced with a new cartridge. Hence, the dispensers comprise some kind of receiving structure that is configured to receive and hold the cartridges.

In order to simplify the change of an empty cartridge sometimes the receiving structures comprise a head plate comprising a swivel mechanism configured to swivel the head plate from a dispensing position into a loading position in which the cartridge can be removed respectively inserted into the receiving structure. This is especially the case when the cartridges are loaded and unloaded from the front, i.e. at the dispensing end, of the dispenser.

Alternatively, some known devices are configured such that the complete receiving structure can be rotated from a dispensing into a loading position and vice versa.

The swivel axis of known devices is usually aligned with the dispensing axis of the dispenser such that the head plate or the head plate and/or the receiving structure can be rotated out of the dispensing plane, i.e. the plane in which the receiving structure lies during use of the dispenser.

### SUMMARY

It has been discovered that the above described mechanisms have disadvantages both in view of easy handling, especially when flexible cartridges are being used, as well as in view of stability during use of the dispenser.

Therefore, it is an object of the disclosure to provide a dispenser which can overcome the above mentioned drawbacks. This object is solved by a dispenser for dispensing materials stored inside a cartridge comprising the features described in the present disclosure.

In particular, the dispenser according to the disclosure comprises a receiving space for repeatedly receiving a cartridge, for example a solid cartridge or a flexible cartridge in a support sleeve, and at least one piston connected to respectively connectable to a piston driving mechanism, e.g. a rack or rod moveable through the receiving space for urging a material stored in the cartridge along a dispensing axis towards an outlet of the cartridge for dispensing the material stored therein. The dispenser further comprises a support sleeve and a handle comprising a trigger for activating the movement of the piston driving mechanism, e.g. the rack or rod of the dispenser along the dispensing axis.

The disclosure is characterized in that the receiving space is formed by a frame, with the frame being configured to hold the support sleeve during dispense, and in that the receiving space further comprises a pivot mechanism configured to act between the frame and the support sleeve such that the support sleeve can pivot about a pivot axis aligned perpendicularly to the dispensing axis from a first position, i.e. a storing and/or dispensing position, to a second position, i.e. a loading position, and vice versa.

Thus, with the dispenser according to the disclosure it is possible to rotate the support sleeve from the dispensing position into the loading position without having to move the receiving space. That is, only the support sleeve is rotated in and out of the receiving space by the swivel mechanism.

In this connection it is noted that the pivot mechanism according to the disclosure can be configured to rotate the support sleeve up and/or down with respect to the dispensing direction, i.e. vertically up and/or down out of a dispensing plane. In this connection it is noted that the support sleeve can either be pivoted such that its front end, i.e. the dispensing end, faces vertically upwards, or vice versa. Hence, both ways of loading/unloading the support sleeve, i.e. front-loading and back-loading, are generally possible.

Furthermore, by rotating the support sleeve around a pivot axis that is aligned perpendicularly to the dispensing axis, it can, for example, be possible to rotate the support sleeve such that the cartridge can be (un) loaded vertically, i.e. the cartridge can be easily slid into the support sleeve from above by simply placing the dispenser, for example, on a table or anything the like. In this case, the handle of the dispenser can act as a second foot such that the dispenser can be stand on its handle and support sleeve (which is in the loading position). This is a noticeable improvement compared to the conventionally known front- and/or back-loading dispensers with which especially the loading of flexible cartridges has shown to be quite tricky as, for example, one has to grip the cartridges at their flexible end in order to squeeze them from the back into their respective receiving space.

Additionally, according to the disclosure only the support sleeve is pivoted from the dispensing position into the loading position and vice versa, the receiving space, i.e. the frame, can be configured as a solid and/or immovable frame which upon use of the dispenser can hold the support sleeve safely at the dispensing position and which can also withstand the high pressures that can arise at the outlet of the cartridge, i.e. at the dispensing end of the dispenser, when the stored material is dispensed.

According to an embodiment of the disclosure the support sleeve is fixedly connected to the frame. That is, even though the support sleeve can be pivoted into its respective loading and storing positions, it can be fixedly connected to the frame such it can never be disconnected from it. This can improve the stability as well as the durability of the dispenser.

According to a further embodiment the support sleeve can be connected to the frame via the pivot mechanism. Hence, the pivot mechanism can comprise two functions, i.e. the pivoting of the support sleeve as well as the fixing of the support sleeve to the frame.

According to another embodiment the frame can comprise a main body, with the main body comprising at least two side walls arranged in parallel to one another and in parallel to the dispensing axis, a head plate arranged at first end of the frame extending in a direction parallel to the pivot axis of the dispenser, with the first end being a dispensing end of the dispenser, and a basis arranged at a second end of the frame opposite to the head plate and extending in a direction parallel to the pivot axis of the dispenser. In other words, the main body of the frame can be composed of two side walls a head plate and a basis.

The head plate can serve as a contact surface for the head part of the cartridge on which the cartridge can rest upon use. Hence, it can keep the cartridge in its position inside the support sleeve even when the materials stored inside the cartridge are urged towards its outlet.

The basis, on the other hand, can for example serve as a mounting plate which can be attached to the handle of the dispenser and/or through which the piston driving mechanism can protrude.

The side walls can act, for example, as protection walls configured to protect the support sleeve upon use of the dispenser to increase the durability of the dispenser.

According to an alternative embodiment the frame can comprise a main body, with the main body comprising at least two side rods arranged in parallel to one another and in parallel to the dispensing axis, a head plate arranged at first end of the frame extending in a direction parallel to the pivot axis of the dispenser, with the first end being a dispensing end of the dispenser, and a basis arranged at a second end of the frame opposite to the head plate and extending in a direction parallel to the pivot axis of the dispenser.

That is, the difference to the above embodiment is that instead of the two side walls the main body comprises two side rods. By replacing the side walls with two (or more) side rods the amount of material needed can be reduced. Also, the production of the main body can be simplified as a simple rod can be produced rather easily. Also, the pivot mechanism can be easily attached to the rods.

The head plate as well as the basis of the main body can comprise the same features as the head plate and the main body of the above embodiment.

Hence, the head plate can serve as a contact surface for the head part of the cartridge on which the cartridge can rest upon use, and can keep the cartridge in its position inside the support sleeve even when the materials stored inside the cartridge are urged towards its outlet.

The basis, on the other hand, can for example serve as a mounting plate which can be attached to the handle of the dispenser and/or through which the piston driving mechanism can protrude.

According to another embodiment of the disclosure and as already suggested above the basis of the frame can be designed as a base plate configured to be fixed to the dispenser, with the base plate comprising through openings configured to receive the piston driving mechanism, e.g. the rack or rod of the dispenser. Hence, the basis can be used as a mounting plate.

In this connection it is also noted that the basis can also be attached, in particular directly attached, to the handle of the dispenser.

Furthermore, it can be possible that the side walls or the side rods of the frame comprise a length that is greater than a length of the support sleeve. This way the support sleeve can be rotated in and out of its dispensing position without having to remove other parts of the frame as there is enough space for the support sleeve to rotate.

According to a further embodiment the main body of the frame can be built as a single piece. Such a construction can contribute to a higher stability. Furthermore, it can also be easier and faster to produce as such a single piece can, for example, be molded quite easily with commonly known molding techniques.

According to an alternative embodiment the side walls or the side rods, the head plate and the basis are designed as separate pieces that are connectable to form the main body. This can have the advantage that in case one part of the frame breaks or wears down, it can be replaced without having to replace the whole frame.

According to another embodiment of the disclosure the pivot mechanism is configured as a pin and pin receiving structure. Such pivot mechanisms are rather easy to build while at the same time being reliable and durable. Furthermore, such a pivot mechanism can generally be positioned at any position along the length of the frame.

In this connection it is further noted that the pin receiving structure can generally comprise any given shape which is suitable for receiving and holding the pin such that it enables the support sleeve to rotate.

Furthermore, it can be possible that the pin is positioned at the support sleeve and the pin receiving structure is designed at the frame of the dispenser, in particular at the side walls or the side rods of the frame.

In such a case the pin receiving structure can be a part of the frame, with the pin receiving structure being arranged on an internal surface of the frame, in particular the internal surface of at least one of the side walls or of at least one of the side rods, with the internal surface of the frame facing the support sleeve. Thus, the pin receiving structure can, for example, be designed as a through hole in a side wall of the frame configured to receive the pin. In alternative embodiments the side walls or side rods can comprise an additional protrusion with the pin receiving structure being positioned at the protrusion, for example as a hole, a recess or anything the like.

Alternatively, the pin can be positioned at the frame of the dispenser and the pin receiving structure is designed at the support sleeve. In this case, the pin receiving structure can also be a part of the support sleeve, with the pin receiving structure being arranged on an outer surface of the support sleeve, with the outer surface of the support sleeve facing the frame. The pin receiving structure can thus, for example, be designed as a hole in the support sleeve. Alternatively, the support sleeve can comprise an additional protrusion on its outer surface at which the pin receiving structure is positioned, for example as a hole, a recess or anything the like.

According to another embodiment the pin receiving structure is designed as an opening, with the opening preferably comprising a circular, oval or rectangular shape. This is one of the simplest ways of providing a pin receiving structure. Additionally, it is also one of the solutions that is least prone to failure. Furthermore, the oval shape, for example, allows for the support sleeve to move along the longitudinal axis of the dispenser to take up tolerances with in the receiving structure and support sleeve, and allows for the movement of the support sleeve to compensate for the pivot geometry.

According to a further embodiment the pivot mechanism is arranged at a middle section of the support sleeve and/or of the frame, with the middle sections respectively extending along the dispensing axis. It can thus be possible to arrange the pivot mechanism at the centre of the support sleeve and/or the frame with respect to their length along the dispensing axis such that the support sleeve can be rotated around its centre with respect to its length.

According to another embodiment the pivot mechanism can be arranged centrally with respect to a width, i.e. a diameter, of the support sleeve. Alternatively, the pivot mechanism can also be arranged off-axis with respect to a width, i.e. a diameter, of the support sleeve. Hence, depending on the dimensions of the support sleeve as well as the side walls or the side rods and/or the application of the dispenser, the precise position of the pivot mechanism with respect to the width of the support sleeve can be chosen accordingly.

According to a further embodiment the pivot mechanism can comprise a pivot plate, with the pivot plate being configured to pivot the support sleeve around the pivot axis. Thus, the support sleeve can be fixed to the pivot plate such that by pivoting the plate the whole support sleeve is moved with it.

In this connection it is noted that at least during use of the dispenser the pivot plate can be arranged at a back end of the frame opposite to a dispensing end of the dispenser, in particular at the second end of the frame. Such a configuration can particularly be suitable for applications in which a cartridge is supposed to be loaded from the front end, i.e. from the dispensing end.

Alternatively, it can also be possible that at least during use of the dispenser the pivot plate is arranged at a front end of the frame, i.e. the dispensing end of the dispenser. This configuration is particularly suitable for the so-called back-loader where a cartridge is loaded into its support sleeve from the back of the support sleeve.

According to a further embodiment the pivot plate and the support sleeve can be fixedly connected to one another to enhance the stability of the dispenser. It can even be possible that the support sleeve and the pivot plate are made out of a single piece. According to another embodiment the pivot plate can be movable along the dispensing axis of the dispenser, in particular along the frame. A movable pivot plate can contribute to simplifying the loading and unloading processes of the cartridges since once the support sleeve is pivoted out of its receiving space it can be moved together with the pivot plate along the dispensing axis such that an ideal loading/unloading angle for each user can be guaranteed.

According to another embodiment the pivot plate can comprise a holding space configured to receive, in particular repeatedly receive, and hold the support sleeve. That is, the pivot plate and the support sleeve can be connectable with one another at the holding space. It can even be possible that the holding space in configured such that the support sleeve can repeatedly be connected respectively disconnected with/from the pivot plate. This can be advantageous in case the support sleeve needs to be exchanged.

According to a further embodiment the pivot mechanism comprises at least one, in particular two, pivot element configured to connect the pivot plate to the frame. That is, the pivot plate may not be directly (and pivotably) connected to the frame but can rather comprise at least one pivot element that is arranged between the pivot plate and the frame such that it connects the two part to one another but still ensures that the pivot plate is pivotable with respect to the frame.

According to another embodiment the dispenser comprises at least one stop feature configured to restrict the pivot movement of the support sleeve, with the at least one stop feature being arranged at the frame and configured to act with the support sleeve in order to restrict the pivot movement of the support sleeve, in particular to a maximum rotation, for example 60 to 120° especially of around 90° or 90°. The stop feature can thus be configured such that the support sleeve cannot rotate completely around its pivot axis. On the contrary, the rotation of the support sleeve is stopped at a certain angle that can be chosen for example to lie in the range of 90 to 120° thereby ensuring that the support sleeve faces the user such that the user can easily load/unload a cartridge.

In this connection it is noted that the stop feature can be designed as a first fixing, e.g. a first bolt, that is arranged at the internal surface of at least one of the side walls or the side rods of the frame and positioned such that it hinders the support sleeve to rotate beyond a maximum rotation angle, for example 60 to 120° especially of around 90° or 90°.

The stop feature can further also comprise a second fixing, e.g. a second bolt, arranged at an opposite internal surface of the other side wall or the other side rod. The second fixing can support the first fixing in hindering the support sleeve to rotate beyond a predetermined maximum rotation angle.

In some cases the first and second fixings can also be connected to one another by a first connection element. The connection element can thus bridge the first and second fixing to create a contact surface that hinders the support sleeve to rotate beyond a predetermined maximum rotation angle. It can also be possible that the first and second fixings and the connection element are formed as a single piece.

The connection element can further be connected to each fixing via a connection plate. The connection plate respectively the two connection plates in the case that two fixings are provided can be arranged such that it vertically protrudes from a dispensing plane such that the connection element is arranged above the dispensing plane, i.e. vertically above the frame of the dispenser.

According to an alternative embodiment the stop feature can comprise a fixing, e.g. a leg, and a holding ring configured to rotate with the support sleeve around the pivot axis and further configured to hinder the support sleeve from rotating beyond a maximum rotation angle, for example 60 to 120° especially of around 90° or 90°. In this case the holding ring can be configured to surround the support sleeve such that it rotates with it. The fixing can be arranged at the holding ring such that it contacts the side walls or the side rods of the frame when the support sleeve reaches the predetermined maximum rotation angle.

In this connection it should be noted that in the case of a two-component cartridge, which is often configured as two side-by-side containers, the holding ring obviously comprises the shape of an eight such that it surrounds both containers, i.e. the complete cartridge.

It can also be possible that the stop features comprises two fixings, i.e. one at each side wall/side rod that contact the frame when the support sleeve reaches the maximum rotation angle.

According to a further embodiment the dispenser can comprise a lock mechanism configured to lock the support sleeve in the dispense position, i.e. with the support sleeve being aligned parallel to the dispensing axis, with the lock mechanism in particular being designed as a clip. Such a lock mechanism can improve the stability of the dispenser during use as it hinders the support sleeve from unintentionally rotating out of its dispensing position.

According to another embodiment the support sleeve can further comprise first and second ends and a longitudinal axis extending therebetween, with the second end extending radially outwardly from the longitudinal axis, i.e. having a trumpet shape, and with the support sleeve being configured to receive the cartridge. Such a configuration can especially be advantageous for applications where the cartridge is supposed to be inserted into the support sleeve at the second end. The trumpet shaped like second end helps the user to more easily insert (respectively pull out) the cartridge into (of) the support sleeve.

According to a further embodiment the dispenser can further comprise at least one stability foot configured to support the dispenser in a/the loading position. That is, once the support sleeve is rotated in its loading position, in particular until its predetermined maximum rotation angle, the rotated support sleeve and/or the handle can act as a first foot while the at least one stability foot can act as a second foot such that the dispenser can be set up in its loading position without a user having to hold onto it.

According to another embodiment the support sleeve can be configured to receive a single cartridge, for example the solid cartridge or the flexible cartridge. According to an alternative embodiment the support sleeve can be configured to receive two cartridges, for example solid cartridges and/or flexible cartridges.

In this connection it should be noted that the two cartridges, for example solid cartridges and/or flexible cartridges, can be arranged side by side to one another or coaxially to one another. Both of the above arrangements are suitable for so-called two-component applications where the materials stored inside the cartridges are supposed to be mixed with one another when the materials are dispensed. The choice of arrangement can depend on the precise application of the dispenser.

According to another embodiment the dispenser can further comprise a second piston configured to urge a material stored in the second cartridge, for example the solid cartridge and the flexible cartridges towards an outlet of the second cartridge for dispensing the material stored therein.

In this connection it should be noted that the dispenser can also be configured to move the first and second piston simultaneously. This is particularly the case when the materials stored inside the cartridges are supposed to be mixed with one another.

According to alternative embodiments the first and second pistons could also be moved independently from one another. This can be the case when the materials stored inside the cartridges are supposed to be dispensed one after the other or at a certain ratio. In such cases it can be helpful when each piston can be moved independently from the other.

### BRIEF DESCRIPTION OF THE DRAWINGS

Further embodiments of the disclosure are described in the following description of the Figures. The invention will be explained in the following in detail by embodiments and with reference to the drawings in which is shown:

FIG. 1 shows details of a frame and support sleeve according to the disclosure;

FIG. 2 is an exemplary side view of FIG. 1;

FIG. 3 is an alternative solution to FIG. 2;

FIG. 4 is another alternative solution to FIG. 2;

FIGS. 5A to 5C illustrate a first embodiment of the dispenser according to the disclosure;

FIGS. 6A to 6B illustrate a second embodiment of the dispenser according to the disclosure;

FIG. 7 is a top view of the frame and support sleeve according to FIG. 6;

FIG. 8 is a cross section of the frame and support sleeve according to FIG. 6;

FIGS. 9A to 9C are side views of the embodiment of FIG. 6;

FIGS. 10A and 10B are two detailed views of possible rear ends of the support sleeves and corresponding pistons;

FIGS. 11A and 11B illustrate a third embodiment of the dispenser according to the disclosure;

FIG. 12 is a side view of the dispenser of FIG. 11;

FIGS. 13A to 13C are an exemplary embodiment of the lock mechanism at the trumpet shape feature;

FIG. 14 shows a support sleeve with the lock mechanism;

FIG. 15 shows another support sleeve with the lock mechanism;

FIG. 16 shows another embodiment of the dispenser according to the disclosure;

FIG. 17 shows another embodiment of the dispenser according to the disclosure;

FIGS. 18A to 18D show another embodiment of the dispenser according to the disclosure;

FIGS. 19A and 19B show another embodiment of the dispenser according to the disclosure;

FIGS. 20A and 20B show another embodiment of the dispenser according to the disclosure;

FIGS. 21A and 21B show details of FIGS. 20A and 20B; and

FIGS. 22A to 22C illustrate another embodiment of the dispenser according to the disclosure.

### DETAILED DESCRIPTION

Throughout the Figures different embodiments of the dispenser 10 according to the disclosure are shown. However, all of the shown dispensers 10 have several features in common, which will be described in the following.

The dispenser 10 according to the disclosure comprises a receiving space 12 for repeatedly receiving a cartridge 14. As can be seen in the Figures, the cartridge 14 can either be a single, i.e. 1K-, cartridge 14 containing a material to be dispensed or a double, i.e. a 2K-, cartridge 14 that is configured to contain two or more materials which upon dispense are supposed to be mixed with one another.

The cartridge 14 comprises a cartridge container 114 fixed to a cartridge head 115 with an outlet 18 being formed at the cartridge head 115. The cartridge head 115 is usually made out of a rigid material while the cartridge container 114 can either be formed by a rigid material or of a flexible material. This can be chosen freely in accordance with the application and/or preferences.

The dispenser 10 further comprises a support sleeve 16 that during use of the dispenser 10 covers the cartridge 14. Hence, the support sleeve 16 receives, supports and protects the cartridge 14.

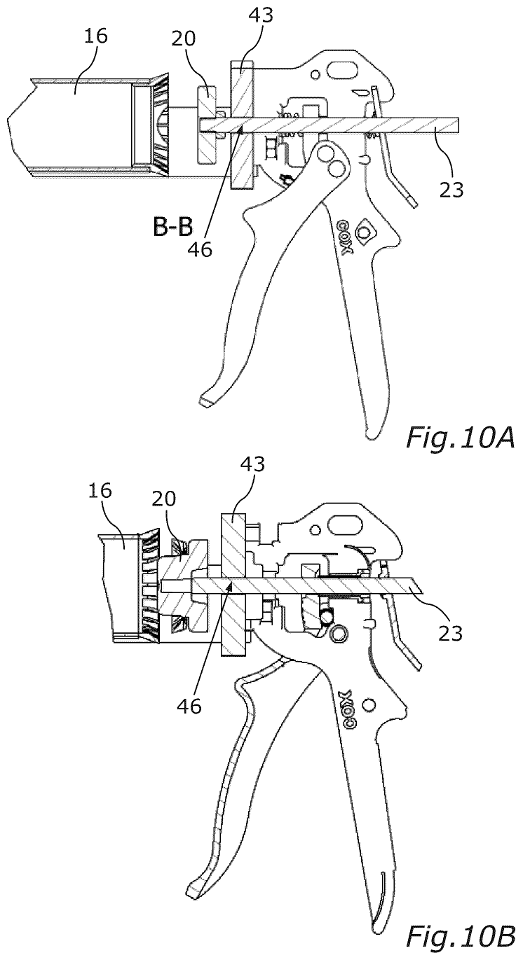

In order to urge the materials stored inside the cartridge 14 along a dispensing axis D towards the outlet 18 of the cartridge 14 the dispenser 10 further comprises at least one piston 20 (see e.g. FIGS. 10A and 10B) that is connected or connectable to a piston driving mechanism 22, e.g. a rack 23 or a rod 23 moveable through the receiving space 12. To activate the piston driving mechanism 22 the dispenser 10 further comprises a handle 24 and a trigger 26 with the trigger 26 being configured to activate a movement of the piston driving mechanism 22. The handle 24 is designed such that it can be gripped and held by a user.

In this connection it should be noted that the dispenser 10 according to the disclosure can be designed as a manual dispenser, as well as a (cordless) electric dispenser and pneumatic dispenser.

The dispenser 10 according to the disclosure further comprises a frame 28 that forms the receiving space 12 and which can be connectable to the handle 24 of the dispenser 10. The frame 28 is configured to hold the support sleeve 16 at least during dispense of the material, i.e. during use of the dispenser 10. It can however also be configured such that the support sleeve 16 is fixedly connected to the frame 28 such that the frame 28 generally holds the support sleeve 16 also when the support sleeve 16 is not in its dispensing position.

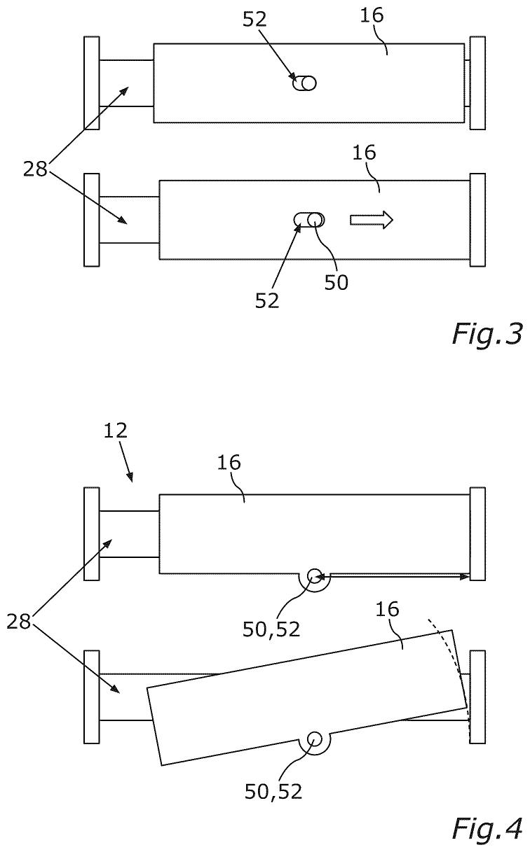

The reason for the support sleeve 16 not always being in its dispensing position is that the receiving space 12 further comprises a pivot mechanism 30 that is configured to act between the frame 28 and the support sleeve 16 such that the support sleeve 16 can pivot about a pivot axis P from a first position, i.e. the storing and/or dispensing position, to a second position, i.e. the loading position, and vice versa. The pivot axis P is aligned perpendicularly to the dispensing axis D such that, as seen from the Figures point of view, the support sleeve 16 can pivot from a horizontal to a vertical direction (see e.g. FIGS. 2 to 4).

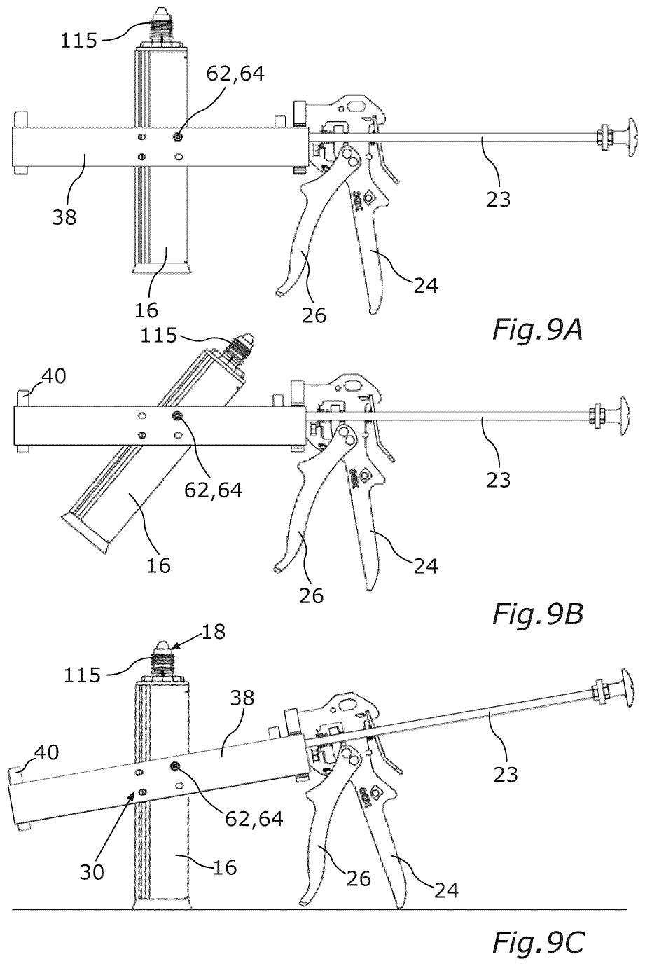

By bringing the support sleeve 16 into a loading position where a front end 32, i.e. a dispensing end, of the cartridge 14 respectively the support sleeve 16 faces upwards, i.e. towards the user of the dispenser 10, a change of the cartridge 14 can be done in a particularly easy way. Furthermore, it can also be possible that by bringing the support sleeve 16 into its loading position the dispenser 10 can stand on its handle 24 and a rear end 34 of the support sleeve 16 such that during the change of a cartridge 14 the user does not necessarily have to hold the dispenser as it can stand on its own (see e.g. FIG. 9C).

The pivot mechanism 30 that enables the support sleeve 16 to pivot is described further below in connection with the different embodiments of the disclosure.

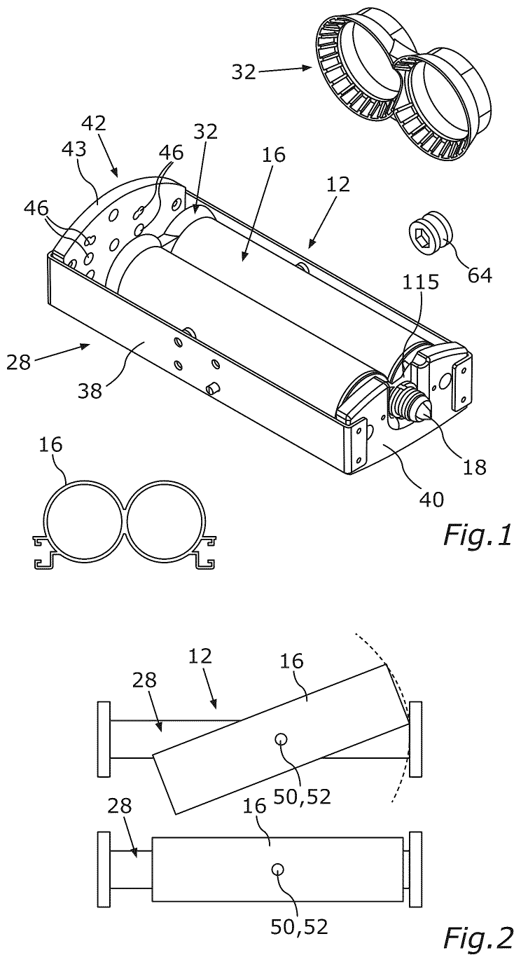

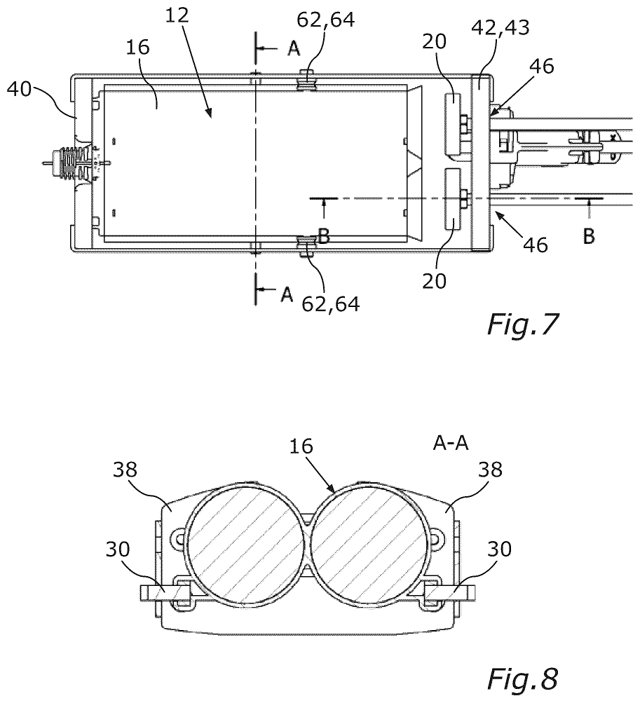

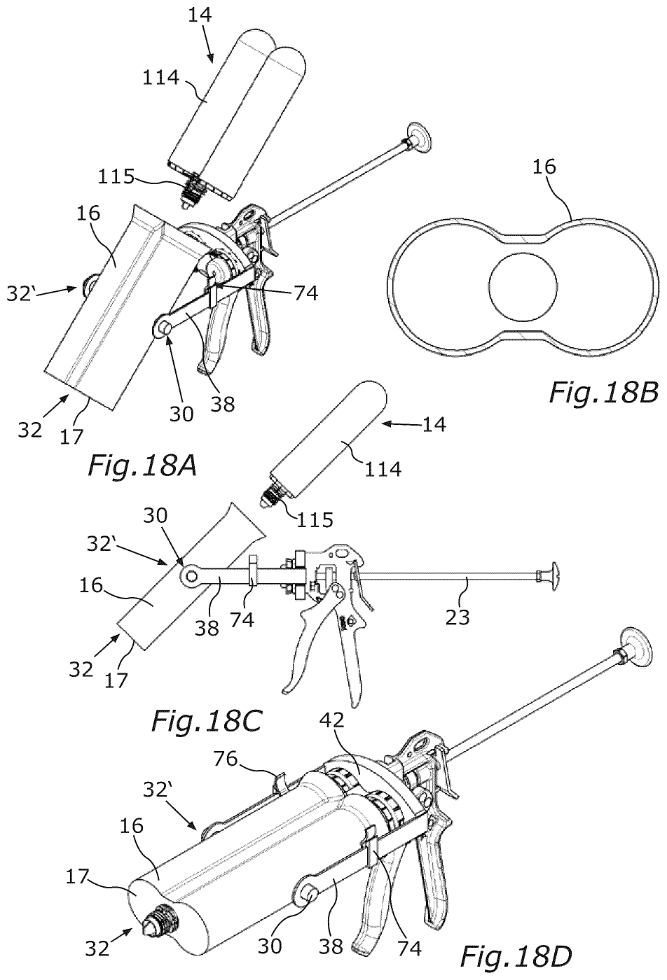

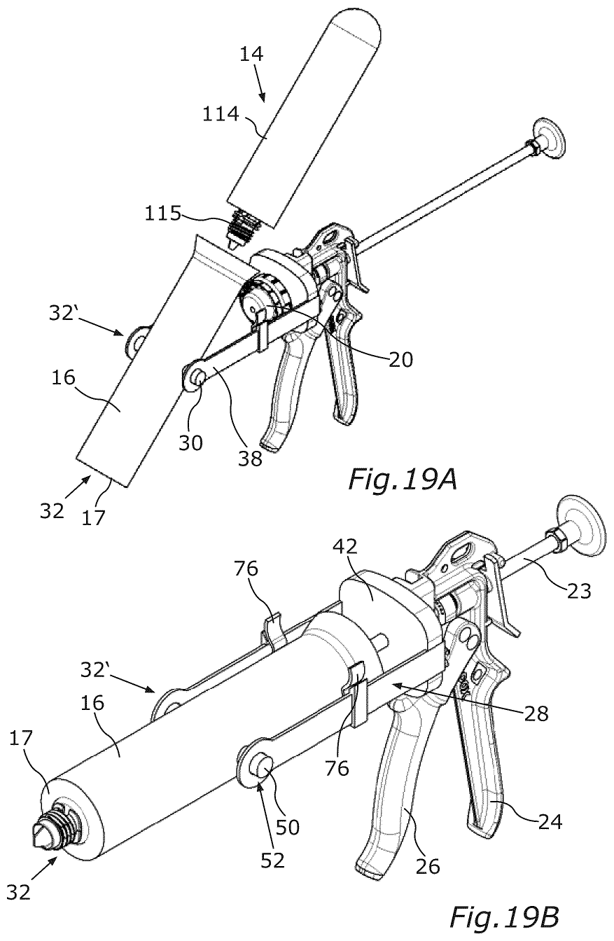

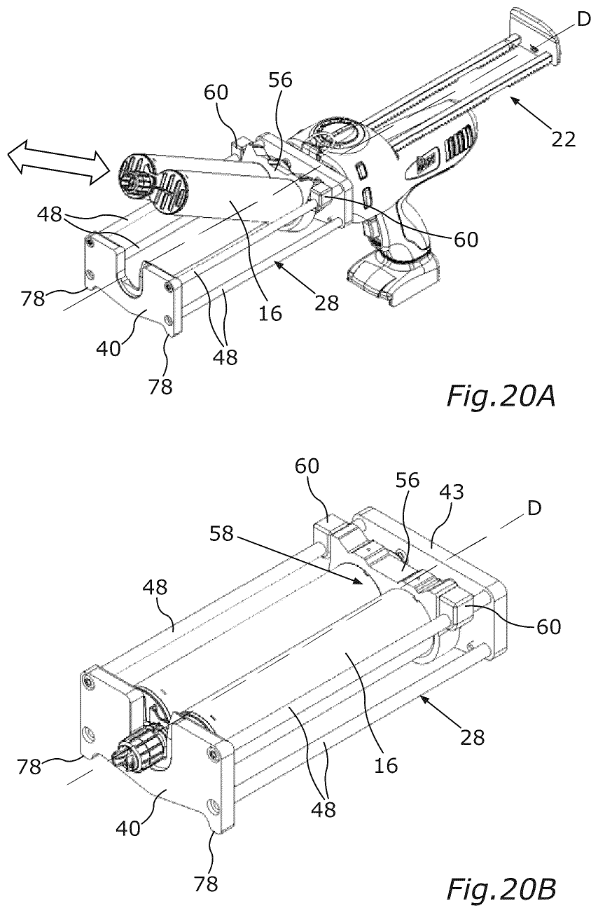

The frame can be formed in different ways. A first embodiment of the frame 28 according to the disclosure is shown in FIGS. 1 to 17 while a second embodiment is shown in FIGS. 18A to 19B and a third embodiment of the frame 28 is shown in FIGS. 20A to 22C.

According to the first embodiment the frame 28 comprises a main body 36 with the main body 36 comprising at least two side walls 38 arranged parallel to one another along the dispensing axis D, a head plate 40 that is arranged parallel to the pivot axis P at the dispensing end 32 and a basis 42 that is arranged at the rear end 34 and parallel to the pivot axis P. That is, the main body 36 of the frame 28 forms the receiving space 12 for the support sleeve 16.

The two side walls 38 as shown in the Figures are designed such when the support sleeve 16 is in its dispensing position, the side walls 38 protect the support sleeve 16 from external influences.

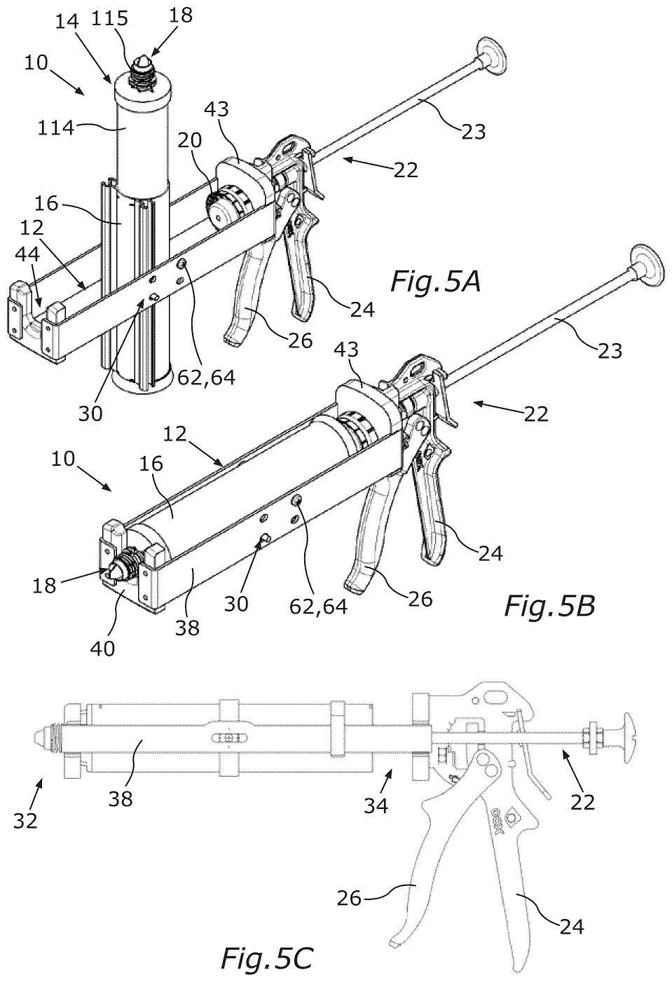

The head plate 40 comprises a recess 44 configured to receive at least a part of the cartridge head 115, in particular the part of the cartridge head 115 at which the outlet 18 is formed, when the support sleeve 16 together with the cartridge 14 is in its dispensing position. That is, when the support sleeve 16 is pivoted in its dispensing position, a part of the cartridge head 115 rests in the recess 44 of the head plate 40. This keeps the cartridge 14 from moving in a direction along the pivot axis P during dispense of the materials as the cartridge head 115 is received by the recess 44. The rest of the cartridge head 115, in particular the part facing the dispensing end 32 of the dispenser 10, however, aligns with the head plate 40 such that also a movement of the cartridge 14 in the dispensing direction is prevented (see e.g. FIGS. 5B, 5C, 6A, 7, 11A).

The basis 42 can be formed by a base plate 43 configured to be connected to the handle 24 of the dispenser 10. It can further also comprise one or several through openings 46 through which the piston driving mechanism 22, in particular the rack or the rods 23, can extend (see e.g. FIGS. 5A to 7, 9A to 12 and/or 16 to 20A).

The third embodiment of the frame 28 does not differ much from the first embodiment (see FIGS. 20A to 22C). The difference between these two embodiments is merely that instead of having two side walls 38 the frame 28 of FIGS. 20A to 22C comprises side rods 48, in particular four side rods 48, to which the pivot mechanism 30 as well as the support sleeve 16 are attached to.

The head plate 40 and the basis 42 of the frame 28 of the third embodiment are generally the same as the ones from the first embodiment of the frame 28 and are thus not described again.

In both the first and third embodiment, the side walls 38 and/or side rods 48 can comprise a length that is at least slightly larger than a length of the support sleeve 16 in order to enable the support sleeve 16 to rotate inside its receiving space 12 (see e.g. FIG. 2 to 4, 5C or 7).

The frame 28 according to the second embodiment is shown in FIGS. 18A to 19B. According to this embodiment the main body 36 of the frame 28 is formed of two side walls 36 and a basis 42 formed of a base plate 43. According to this embodiment the front end 32′ of the frame 28 does not comprise a head plate or anything the like. On the contrary, the pivot mechanism 30 of the dispenser 10 is arranged at the front end 32′ of the frame 28.

Therefore, the front end 32′ of the frame 28 does not align with the dispensing end 32 of the dispenser 10 as the side walls 38 of the frame 28 comprise a length that is about half as long as the length of the support sleeve 16, such that the pivot axis P aligns with the front end 32′ of the frame 28. Thus, the support sleeve 16 pivots around the front end 32′ of the frame 28.

However, as the frame 28 of FIGS. 18A to 19B does not comprise a head plate, the support sleeve 16 is designed such that it comprises a support plate 17 at the dispensing end 32 which is configured to hold the cartridge 14 inside the support sleeve 16 during dispensing, thereby comprising the same functioning as the head plate 40 of the frame 28. The support plate 17 obviously comprises at least one opening configured to receive the outlet 18 of the cartridge 14. The support plate 17 can either be formed as a single piece that is connected to the support sleeve 16 or the support sleeve 16 and the support plate 17 can be formed integrally.

In all three embodiments of the frame 28 that support sleeve 16 can either be fixedly connected to the frame 28 or releasably. That is, in some embodiments it can be possible to remove the support sleeve 16 from the frame 28. This might be the case, for example, when the support sleeve gets damaged or is supposed to be cleaned. In some cases, however, it is not necessary to remove the support sleeve 16 from the frame 28 which is why it can also be fixedly connected to the frame 28.

Often, the support sleeve 16 is connected to the frame 28 via the pivot mechanism 30. Hence, the pivot mechanism 30 is described in more detail in the following.

For example, the pivot mechanism 30 can be configured as a pin 50 and a pin receiving structure 52 which is shown in most of the Figures. The pin 50 can, for example, be arranged at the support sleeve 16 while the pin receiving structure 52 is arranged at the frame 28, in particular at the side walls 38 of the frame (see e.g. FIGS. 5A to 9C and 18A to 19B). According to an alternative embodiment (not shown) the pin 50 and pin receiving structure 52 could also be arranged vice versa, i.e. the pin 50 at the frame 28 and the pin receiving structure 52 at the support sleeve 16.

The pin receiving structure 52 can, for example, be formed by an opening into which the pin 50 can be inserted such that the support sleeve 16 can pivot around the pivot axis P. Hence, in this case the pin receiving structure 52 is a part of the frame 28. The opening can comprise different shapes such as for example a circular, an oval or a rectangular shape. This allows some movement of the support sleeve 16 with respect to the frame 28 to allow for variations in part dimensions and to take up movement needed for the pivot.

In this connection it should be noted that the pivot mechanism 30 can either be arranged centrally along a width of the support sleeve 16 (see e.g. FIG. 2) or off-axis along a width of the support sleeve 16 (see e.g. 4).

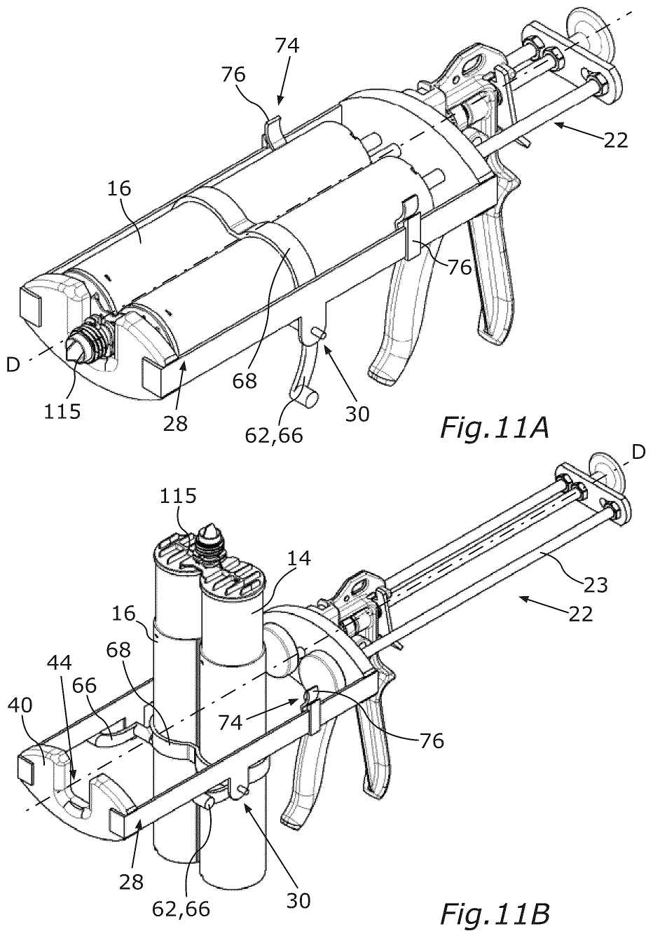

The latter case can also be seen e.g. in FIGS. 11A to 12 and FIGS. 20A to 22C. This configuration can provide a better alignment of the support sleeve 16 with respect to the frame 28, i.e. with respect to the dispensing axis D of the dispenser 10, when it is rotated in its dispensing position. In this connection it is also noted that in the embodiments shown in FIGS. 20A to 22C the pivot mechanism 30 is additionally also free to move along the dispensing axis D of the dispenser 10.

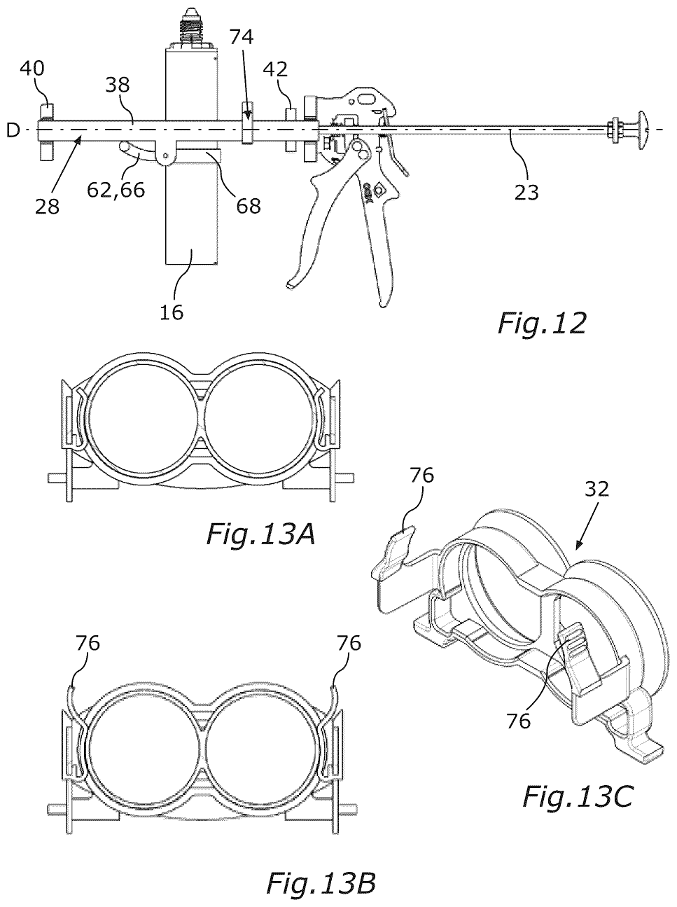

According to the embodiments of FIGS. 11A to 12C the side walls 38 of the frame 28 comprise an additional protrusion 54 at which the pin receiving structure 52, i.e. the opening, is formed.

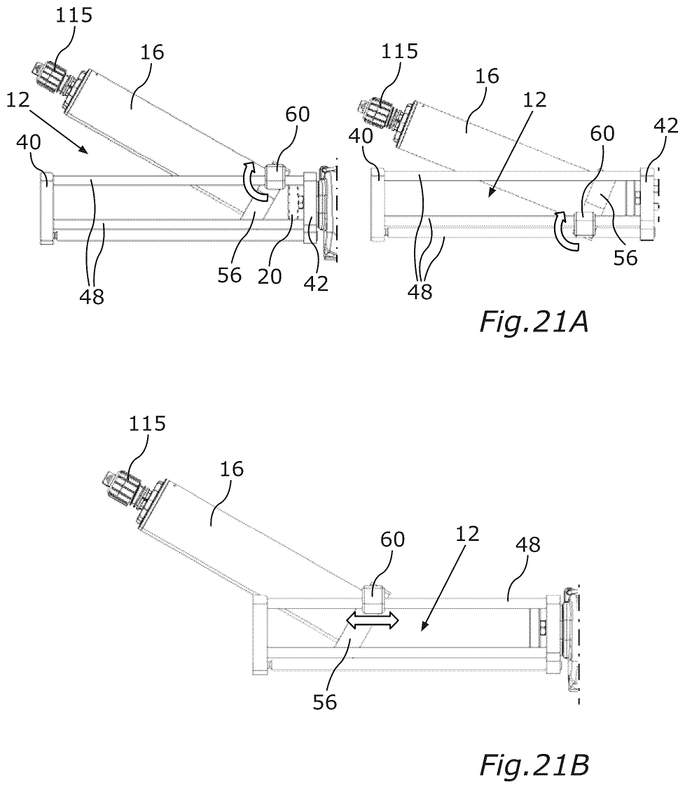

According to the embodiment shown in FIGS. 20A to 22C, on the other hand, the pivot mechanism 30 is arranged between two of the four side rods 48 of the frame 28, i.e. the upper two side rods 48 as seen in FIGS. 20A, 20B, 21B, 22A to 22C as well as the left hand side of 21A. The left hand side of FIG. 21A shows an embodiment with the pivot mechanism 30 being arranged at the lower side rods 48 of the frame 28. That is, the pivot mechanism 30 according to FIGS. 20A to 22C comprises a pivot plate 56 that is pivotably connected with two of the four side rods 48. Upon use of the dispenser 10, the pivot plate 56 is arranged at the rear end 34, i.e. in next to the basis 42 of the frame 28.

The pivot plate 56 is configured to be connected to the support sleeve 16 such that upon a pivotable movement of the pivot plate 56 the support sleeve 16 also pivots around the pivot axis P. Hence, in this case in can be possible that the pivot axis P is arranged at the rear end 31 of the support sleeve 16.

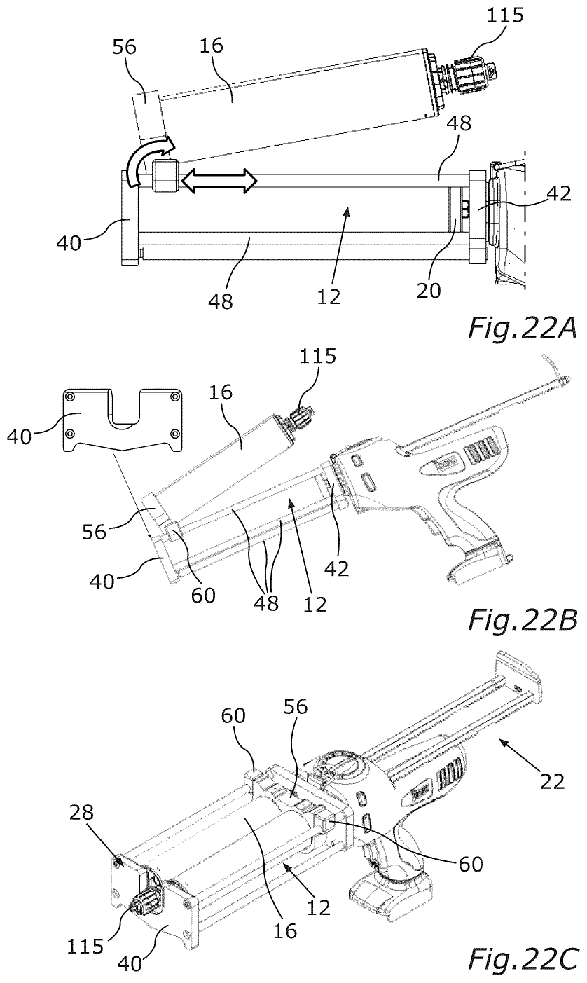

However, in some cases it can also be possible that the pivot plate 56 is movable along the receiving space 12 which can be seen in FIGS. 21A to 22C. In this case, the support sleeve 16 can first be pivoted out of its receiving space 12 and then moved along the side rods 48. If wanted, it can also be possible to then rotate the support sleeve 16 further until it reaches a predetermined rotation angle which allows the user to easily access the support sleeve 16 and change the cartridge 14 that is arranged inside the support sleeve 16. As can be seen in FIGS. 22A to 22C it can even be possible that the support sleeve 16 is pivoted into a loading position at which the dispensing end 32 of the support sleeve 16 faces the handle 24 of the dispenser 10.

The pivot plate 56 and the support sleeve 16 can be fixedly connected to one another or releasably. For both cases the pivot plate can comprise a holding space 58 that is configured to receive and hold the support sleeve 16, in particular the rear end 34 of the support sleeve 16.

In this connection it is noted that in case the support sleeve 16 and the pivot plate 56 are fixedly connected to one another at the rear end 34 of the support sleeve 16, the cartridge 14 can be loaded and unloaded at the dispensing end 32 of the support sleeve 16 as the rear end 34 is covered by the pivot plate 56. Nevertheless, in this case the pivot plate 56 still comprises at least one opening (not shown) configured to receive the at least one piston 20 of the dispenser 10.

In the case of the support sleeve 16 and the pivot plate 56 being releasable from one another, the cartridge 14 could generally also be loaded/unloaded at the rear end 34 of the support sleeve 16.

The pivot plate 56 can further comprise one or more pivot elements 60 configured to pivotably connect the pivot plate 56 to the frame 28, i.e. to the side rods 48 as shown for example in FIGS. 20A to 22C. The pivot elements 60 and the pivot plate 56 can for example be connected via a joint (not shown) that enables the pivot plate 56 to pivot with respect to the frame 28. The pivot elements 60 can, for example, surround the side rods 48 in such a way that are fixedly connected to the side rods 48 while at the same time being movable along the dispensing axis D with respect to the frame 28.

The dispenser 10 can further comprise at least one stop feature 62 that is arranged at the frame 28 and that is configured to act between the support sleeve 16 and the frame 28 in order to restrict the pivot movement of the support sleeve 16 to a predetermined maximum rotation angle. The maximum rotation angle can, for example, lie in the range of 60 to 120°, which can be seen in FIGS. 5A, 5B and 6 to 7, 9A and 9B, 11A to 12 and 14 to 17. The stop feature 62 can further be designed in several different ways.

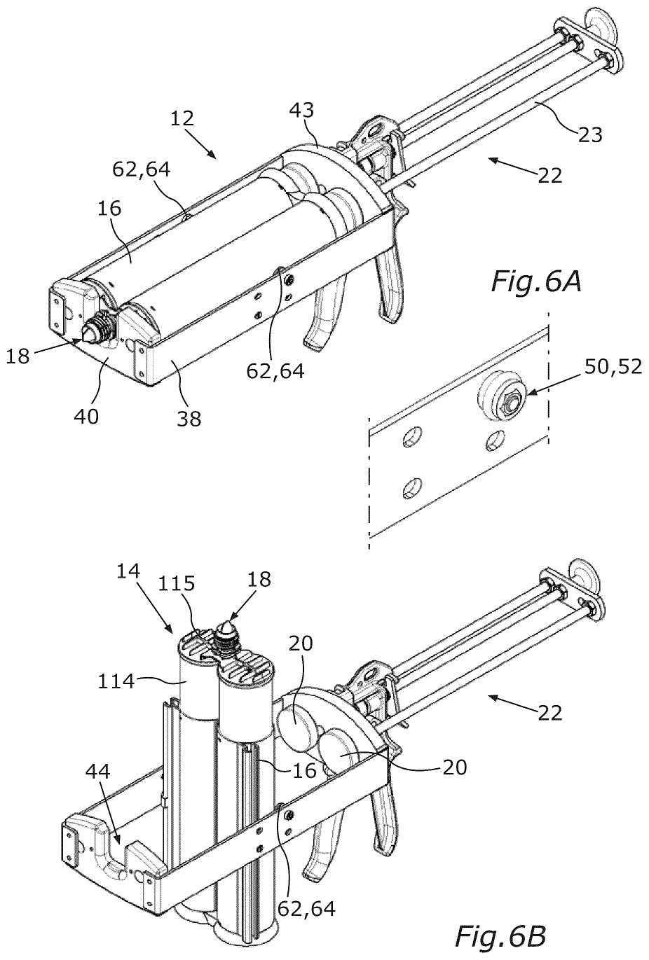

A first embodiment of the stop feature 62 is shown in FIGS. 5A, 5B, 6, 7 and 9A to 9C where two stop features in the form of a first and second fixing 64 are provided, one fixing 64 at each side wall 38. The first and second fixings 64 are arranged at an inner surface 39 of the respective side wall 38 such that wen the support sleeve 16 is pivoted in in its loading position, the support sleeve 16 contacts the fixings 64 such that it cannot rotate any further. When the support sleeve 16 is in its dispensing/storing position the fixings 64 do not touch the support sleeve 16 (see e.g. FIG. 6A und 6B).

Generally, one fixing 64 would be enough to prevent the support sleeve 16 from rotating beyond a predetermined maximum rotation angle. On the other hand, it could also be possible to arrange more than two fixings 64 with the fixings 64 supporting each other.

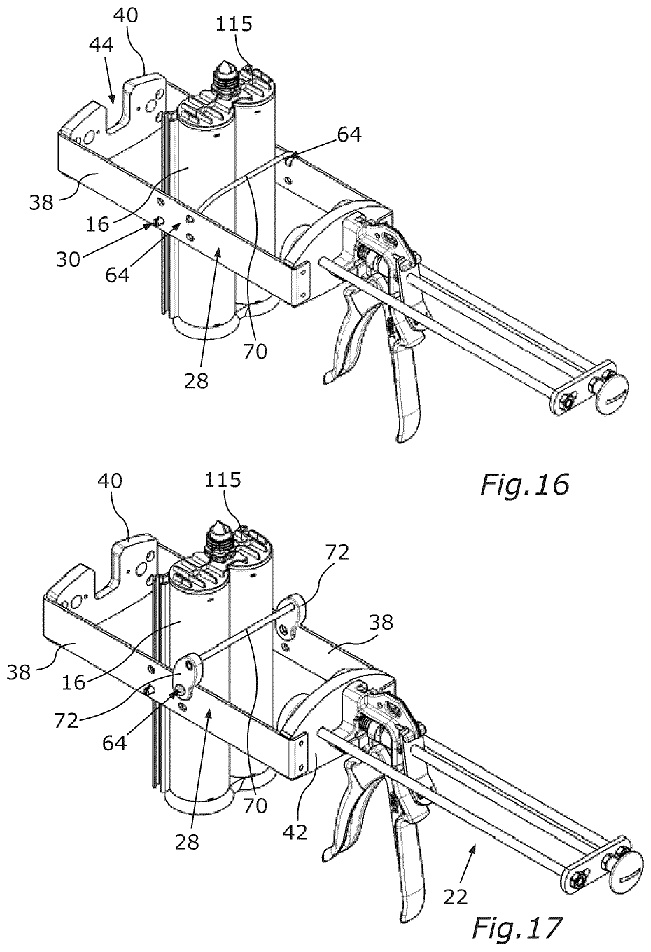

As one can see in FIGS. 16 and 17, the first and second fixings 64 can also be connected with one another by a connection element 70 which can be formed, for example, by a rod that is provided between the first and second fixings 64. The connection element 70 can be arranged such that the support sleeve 16 contacts the connection element 70 once it reaches its maximum rotation angle.

The connection element 70 can be directly connected to the first and second fixings 64, The connection element 70 and the fixings 64 can even be formed as a single piece as can be seen in FIG. 16.

Alternatively, the connection element 70 can also be connected to the fixings 64 via a connection plate 72 that is arranged between each fixing 64 and the connection element 70 (see FIG. 17). Such a connection plate 72 can, for example, be used when the connection element 70 is supposed to be arranged at a certain angle with respect to the frame 28. Additionally, it could also be possible that by using the connection plates 72 each user can arrange the connection element 70 at a certain predetermined angle to adjust the maximum rotation angle of the support sleeve 16 by simply changing the alignment of the connection plates 72 with respect to the side walls 38.

A further embodiment of the stop features 62 is shown in FIGS. 11A to 12.

According to this embodiment the stop features 62 comprises at least one leg 66 that is connected to or that is part of a holding ring 68 and that faces away from the support sleeve 16 (see e.g. FIG. 11A). Thus, the leg(s) 66 can either be formed as a separate part that is connected to the holding ring 68 or the holding ring 68 and the leg(s) 66 can be formed, i.e. molded, integrally as a single piece.

The holding ring 68 surrounds the support sleeve 16 such that it can rotate together with the support sleeve 16 around the pivot axis P. Hence, the holding ring 68 can further be directly connected to the pivot mechanism 30 such that upon rotation of the support sleeve 16 the leg 66 rotates with it until it touches the frame 28, i.e. the side wall 38 or at least one of the side rods 48, thereby preventing the support sleeve 16 from rotating any further.

By changing the angle at which the leg 66 is arranged with respect to the holding 68, and thus also the support sleeve 16, the maximum rotation angle can be determined.

As can be seen in FIGS. 11A and B, the stop features 62 can comprise two legs 66, one at each side wall 38 which both comprise the functioning.

According to this embodiment, the holding ring 68 can comprise two functions, i.e. it supports the legs 66 that hinder the support sleeve 16 from rotating beyond a predetermined maximum rotation angle. Additionally, the holding ring 68 can serve as the connection between the support sleeve 16, the pivot mechanism 30 and the frame 28.

In some embodiments it can further be possible that the dispenser 10 comprises a lock mechanism 74 that is configured to lock the support sleeve 16 in its dispensing position. Such a lock mechanism 74 is for example shown in FIGS. 11A to 13C and 14 where a clip 76 is arranged at each side wall 38. The clip 76 could also be arranged at the above mentioned holding ring 68 (not shown).

Alternatively, the clip 76 can be arranged at a rear end 34 of the support sleeve 16 as it is depicted in FIGS. 13A to 13B which show a separate molding part that can be added to the rear end 34 of the support sleeve 16 to provide a trumpet shaped rear end 34 which is described further below.

The clips 76 can be moved from an opened (see FIG. 13B) into a closed (see FIG. 13A) position, wherein at the closed position the clips 76 clamp the support sleeve 16 such that it is fixed in its dispensing position. Once the clips 76 are opened again, the support sleeve 16 is free to move and can also be brought into its loading position.

The clips 76, i.e. the lock mechanism 74, can generally be arranged along the whole length of the support sleeve 16. However, it is often preferred to arrange the clip 76 as far away from the pivot mechanism 30 as possible (along the dispensing axis D) to provide a more reliable locking of the support sleeve 16. Furthermore, the lock mechanism 74 can either be arranged at the frame 28 or at a separate part that can be connected to the support sleeve 16 (see FIGS. 13A to 13C).

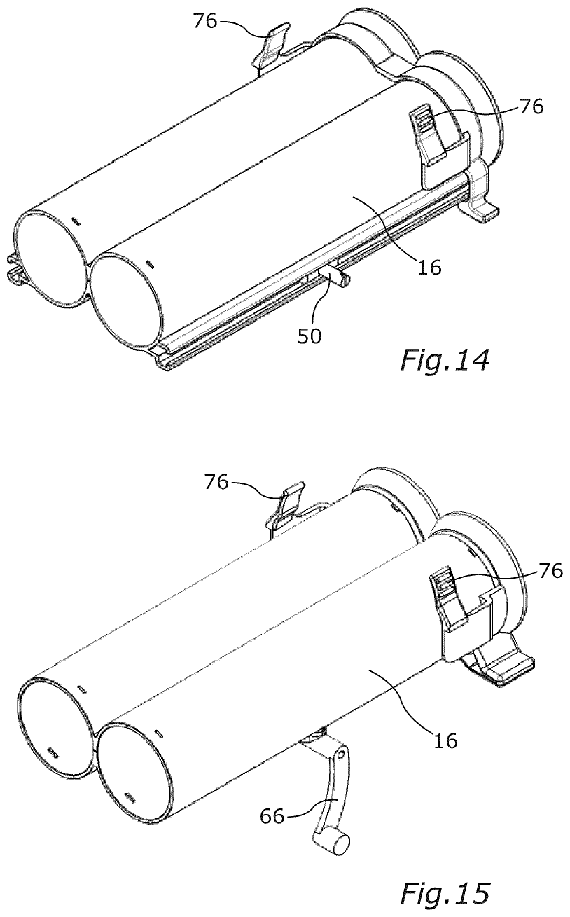

In FIGS. 14 and 15, for example, the lock mechanism 74 is arranged at the rear end 34 of the support sleeve 16 while in FIGS. 18A to 18D or FIGS. 11A to 11B the lock mechanism 74 is arranged at the side walls 38 of the frame 28. Hence, it can be seen that the lock mechanism 74 can be arranged at several different places as long as it is able to lock the support sleeve 16 in its dispensing position. Even though it is not shown in the Figures, it could also be possible that the lock mechanism 74 is arranged at the dispensing end 32 of the support sleeve 16 or somewhere in between.

One can further see in FIGS. 13A to 19B that the rear end 34 of the support sleeve 16 can extend radially outwardly. That is, the rear end 34 can have a trumpet shape. This can particularly be the case when the cartridges 14 are supposed to be loaded/unloaded at the rear end 34 of the support sleeve 16 as a trumpet-shaped rear end 34 simplifies the extraction and insertion of the cartridge 14 from respectively into the support sleeve 16. Additionally, the trumpet shape ensures that the piston 20 of the dispenser 10 can enter the support sleeve 16 with ease as it automatically aligns the piston 20 with respect to the support sleeve 16 upon entering. If the piston 20 was misaligned with respect to the support sleeve 16, it would hit the support sleeve 16 due to the force the dispenser 10 can produce such that the piston 20 and/or the support sleeve 16 could even be damaged.

Furthermore, it can also be possible that the dispenser 10 comprises at least one stability foot 78 that is configured to support the dispenser in the loading position. Such stability feet 78 can for example be seen in FIGS. 20A and 20B. One can see that the dispenser 10 of FIG. 20A, for example, can be tilted such that it stands on its stability feet 78 as well as its handle 24, in particular a battery receiving area of the handle 24, such that a user can easily change the cartridge 14. In this embodiment the stability feet 78 are provided as a part of the head plate 40.

According to other embodiments (not shown) the stability foot 78 could also be arranged as an additional foot that is arranged apart from the handle 24 and the head plate 40 such that when the support sleeve 16 is pivoted in its loading position, the dispenser 10 can stand on its stability foot 78 and the rotated support sleeve 16 and/or its handle 24.

Hence, all embodiments of the dispenser 10 according to the disclosure provide a particularly simple way of changing the cartridges 14 once they are empty and need to be replaced. At the same time, the dispenser 10 according to the disclosure is reliable and stable such that when the dispenser 10 is used, the cartridge 14 is safely stored inside the support sleeve 16 and cannot fall out of the support sleeve 16 even if high pressures act on the cartridge in the dispensing direction.

1. A dispenser for dispensing materials stored inside a cartridge, the dispenser comprising:
a support sleeve;
a receiving space configured to repeatedly receive a cartridge in the support sleeve;
a piston connected to a piston driving mechanism moveable through the receiving space to urge a material stored in the cartridge along a dispensing axis towards an outlet of the cartridge to dispense the material stored therein; and
a handle comprising a trigger to activate movement of the piston driving mechanism along the dispensing axis,
the receiving space being formed by a frame, with the frame being configured to hold the support sleeve (16) during dispensing, and
the receiving space further comprising a pivot mechanism configured to act between the frame and the support sleeve such that the support sleeve is capable of pivoting about a pivot axis aligned perpendicularly to the dispensing axis from a first position to a second position, and vice versa.

2. The dispenser according to claim 1,
wherein the support sleeve is fixedly connected to the frame, or
the support sleeve is connected to the frame via the pivot mechanism.

3. The dispenser according to claim 1,
wherein the frame comprises a main body, with the main body comprising at least two side walls arranged parallel to one another and parallel to the dispensing axis, a head plate arranged at first end of the frame extending in a direction parallel to the pivot axis of the dispenser, with the first end being a dispensing end of the dispenser, and a basis arranged at a second end of the frame opposite to the head plate and extending in a direction parallel to the pivot axis of the dispenser.

4. The dispenser according to claim 1,
wherein the frame comprises a main body, with the main body comprising at least two side rods arranged parallel to one another and parallel to the dispensing axis, a head plate arranged at first end of the frame extending in a direction parallel to the pivot axis of the dispenser, with the first end being a dispensing end of the dispenser, and a basis arranged at a second end of the frame opposite to the head plate and extending in a direction parallel to the pivot axis of the dispenser.

5. The dispenser according to claim 3,
wherein the basis of the frame is a base plate configured to be fixed to the dispenser, with the base plate comprising through openings (46) configured to receive the piston driving mechanism, e.g. the rack or rod of the dispenser.

6. The dispenser according to claim 3,
wherein the basis is attached to a handle of the dispenser, or
the side walls the frame comprise a length that is greater than a length of the support sleeve.

7. The dispenser according to claim 3,
wherein the main body of the frame is built as a single piece, or
wherein the side walls, the head plate and the basis are separate pieces that are connectable to form the main body.

8. The dispenser according to claim 1,
wherein the pivot mechanism is a pin and pin receiving structure.

9. The dispenser according to claim 8,
wherein the pin is positioned at the support sleeve and the pin receiving structure is designed at the frame of the dispenser at the side walls of the frame.

10. The dispenser according to claim 8,
wherein the pin is positioned at the frame of the dispenser and the pin receiving structure is designed at the support sleeve, and the pin receiving structure is a part of the support sleeve, with the pin receiving structure being arranged on an outer surface of the support sleeve, with the outer surface of the support sleeve facing the frame.

11. The dispenser according to claim 8,
wherein the pin receiving structure is an opening, with
the opening comprising a circular, oval or rectangular shape.

12. The dispenser according to claim 1,
wherein the pivot mechanism is arranged at a middle section of the support sleeve or of the frame, with the middle sections extending along the dispensing axis.

13. The dispenser according to claim 1,
wherein the pivot mechanism is arranged centrally with respect to a width of the support sleeve, or
the pivot mechanism is arranged off-axis with respect to the width of the support sleeve.

14. The dispenser according to claim 1,
wherein the pivot mechanism comprises a pivot plate, with the pivot plate being configured to pivot the support sleeve around the pivot axis, at least during operation of the dispenser the pivot plate is arranged at a back end of the frame opposite to a dispensing end of the dispenser at the second end of the frame.

15. The dispenser according to claim 14,
wherein the pivot plate (56) and the support sleeve are fixedly connected to one another, or
the pivot plate is movable along the dispensing axis of the dispenser along the frame, or
the pivot plate comprises a holding space configured to repeatedly receive and hold the support sleeve.

16. The dispenser according to claim 1
wherein the dispenser comprises a stop feature configured to restrict the pivot movement of the support sleeve, with the stop feature being arranged at the frame and configured to act with the support sleeve to restrict the pivot movement of the support sleeve to a maximum rotation of about 60 to 120°.

17. The dispenser according to claim 16,
wherein the stop feature is a first fixing arranged at an internal surface of a first side wall or a first side rod of the frame and positioned to hinder the support sleeve to rotate beyond a maximum rotation angle of about 60 to 120°
with the stop feature comprising a second fixing arranged at an opposite internal surface of a second side wall or s second side rod, with the first and second fixings being connected to one another by a connection element, or
the connection element is connected to the first and second fixings via a connection plate.

18. The dispenser according to claim 16,
wherein the stop feature comprises a fixing and a holding ring configured to rotate with the support sleeve around the pivot axis and further configured to hinder the support sleeve from rotating beyond a maximum rotation angle of about 60 to 120°.

19. The dispenser according to claim 1,
further comprising a lock mechanism configured to lock the support sleeve in the first position with the support sleeve being aligned parallel to the dispensing axis and the lock mechanism being as a clip.

20. The dispenser according to claim 1,
wherein the support sleeve further comprises first and second ends and a longitudinal axis extending therebetween, with the second end extending radially outwardly from the longitudinal axis and with the support sleeve being configured to receive the cartridge.

21. The dispenser according to claim 1,
further comprising a stability foot configured to support the dispenser in the second position.
